(19) United States
(12) Patent Application Publication
(10) Pub. No.: US 2005/0043962 A1
(43) Pub. Date: Feb. 24, 2005

(54) Data processing system, data processing method, data processing terminal used in same, and data processing program

(76) Inventor: Toru Katayama, Tokyo (JP)

Correspondence Address: Whitham, Curtis & Christofferson, P.C., Suite 340, 11491 Sunset Hills Road, Reston, VA, 20190, US

(21) Appl. No.: 10/915,365

(22) Filed: Aug. 11, 2004

(30) Foreign Application Priority Data
Aug. 20, 2003 (JP) 295762/2003

(51) Int. Cl. G06F 17/60

(52) U.S. Cl. 705/1

(57) ABSTRACT

A data processing system, a data processing method, a data processing terminal used in the same, and a data processing program, which enable reliable downloading of information such as electronic ticket data while ensuring security even when an IC card is not set in the terminal. On the occasion when downloading electronic ticket data from a server of a ticket agency through a communication network, if a storage medium such as an IC card to store the data is not mounted in a data processing terminal, the data is encrypted and temporarily stored in an internal memory or a storage device having a capacity larger than that of the internal memory of the data processing terminal. When the storage medium has been mounted in the data processing terminal, the electronic ticket data is read out of the internal memory or the storage device. Thereafter, the electronic ticket data is decrypted and stored in the storage medium. Thus, it becomes possible to download information such as electronic ticket data while ensuring security.

### FIELD OF THE INVENTION

The present invention relates to a data processing system, a data processing method, a data processing terminal used in the same, and a data processing program, and in more particular, to a data processing system in which data including an electronic ticket is received from a server through a communication network, and the data is stored in a detachable or removable storage medium such as an IC card.

### BACKGROUND OF THE INVENTION

There have been proposed electronic ticket systems in, for example, Japanese Patent Application laid open No. 2000-113238 and Japanese Patent Application laid open No. 2002-351623. In the electronic ticket systems, information on tickets for a concert, a performance, an entertainment, etc., and boarding tickets or bus, plane, train, etc. tickets is obtained from servers in ticket agencies or ticket shops through a communication network with a portable information terminal such as a cellular phone, and the information is electronically stored in an IC card. The IC card can be substituted for an ordinary paper ticket.

It is often the case that an IC card is used for storing such electronic ticket because it provides a basis for security against falsification of data, unauthorized copying and the like. However, since the IC card is configured so that it can be attached or removed to or from a portable information terminal at will, data of an electronic ticket is not available for download by operating the information terminal that is not mounted with the IC card. In addition, when the IC card has reached the limit of its storage capacity, the user has to prepare a new IC card or delete data already stored in the IC card to download new data.

As one approach to the aforementioned problems, a message is displayed on the display section of the portable information terminal to require the user to set an IC card or replace the IC card with a new one so that he/she can download data of an electronic ticket. However, the user may not have an IC card which is available to use immediately. In such a case, the data may be temporarily stored in an internal memory of the portable information terminal. However, the internal memory of the portable information terminal is generally inferior to the IC card, etc. in safety level.

### SUMMARY OF THE INVENTION

It is therefore an object of the present invention to provide a data processing system, a data processing method, a data processing terminal used in the same, and a data processing program, which enable reliable downloading of information such as electronic ticket data while ensuring security even when an IC card is not set in the terminal.

In accordance with the first aspect of the present invention, to achieve the object mentioned above, there is provided a data processing system, in which data received through a communication network is stored in a storage medium capable of being freely attached or removed to or from a data processing terminal, wherein: the data processing terminal includes a controller; when the storage medium is not mounted in the data processing terminal, data is encrypted and temporarily stored in an internal memory of the data processing terminal; and the data stored in the internal memory is stored in the storage medium under the control of the controller after the storage medium is mounted in the data processing terminal.

In accordance with the second aspect of the present invention, there is provided a data processing system, in which data received through a communication network is stored in a storage medium capable of being freely attached or removed to or from a data processing terminal, wherein: the data processing terminal comprises an internal memory, a storage device having a capacity larger than that of the internal memory, and a controller; when the storage medium is not mounted in the data processing terminal and also the internal memory has no sufficient space left to store data, the data is encrypted and temporarily stored in the storage device; and the data stored in the storage device is stored in the storage medium under the control of the controller after the storage medium is mounted in the data processing terminal.

In accordance with the third aspect of the present invention, there is provided a data processing method for storing data received through a communication network in a storage medium which is capable of being mounted in a data processing terminal, comprising the steps of: encrypting data to temporarily store the data in an internal memory of the data processing terminal when the storage medium is not mounted in the data processing terminal; and storing the data stored in the internal memory in the storage medium after the storage medium is mounted in the data processing terminal.

In accordance with the fourth aspect of the present invention, there is provided a data processing method for storing data received through a communication network in a storage medium which is capable of being mounted in a data processing terminal, comprising the steps of: encrypting data to temporarily store the data in a storage device of the data processing terminal having a capacity larger than that of an internal memory thereof when the storage medium is not mounted in the data processing terminal and also the internal memory has no sufficient space left to store the data; and storing the data stored in the storage device in the storage medium after the storage medium is mounted in the data processing terminal.

In accordance with the fifth aspect of the present invention, there is provided a data processing terminal, which stores data received through a communication network in a storage medium capable of being freely attached or removed to or from the data processing terminal, including a controller, wherein: when the storage medium is not mounted in the data processing terminal, data is encrypted and temporarily stored in an internal memory of the data processing terminal; and the data stored in the internal memory is stored in the storage medium under the control of the controller after the storage medium is mounted in the data processing terminal.

In accordance with the sixth aspect of the present invention, there is provided a data processing terminal, which stores data received through a communication network in a storage medium capable of being freely attached or removed to or from the data processing terminal, comprising an internal memory, a storage device having a capacity larger than that of the internal memory, and a controller; wherein: when the storage medium is not mounted in the data processing terminal and also the internal memory has no sufficient space left to store data, the data is encrypted and temporarily stored in the storage device; and the data stored in the storage device is stored in the storage medium under the control of the controller after the storage medium is mounted in the data processing terminal.

In accordance with the seventh aspect of the present invention, there is provided a data processing program for a computer to control the operations of a data processing terminal which stores data received through a communication network in a storage medium capable of being freely attached or removed to or from the data processing terminal, the program making the data processing terminal perform the processes of encrypting data to temporarily store the data in an internal memory when the storage medium is not mounted in the data processing terminal; and storing the data stored in the internal memory in the storage medium after the storage medium is mounted in the data processing terminal.

In accordance with the eighth aspect of the present invention, there is provided a data processing program for a computer to control the operations of a data processing terminal which stores data received through a communication network in a storage medium capable of being freely attached or removed to or from the data processing terminal, the program making the data processing terminal perform the processes of: encrypting data to temporarily store the data in a storage device having a capacity larger than that of an internal memory when the storage medium is not mounted in the data processing terminal and also the internal memory has no sufficient space left to store the data; and storing the data stored in the storage device in the storage medium after the storage medium is mounted in the data processing terminal.

That is, in accordance with the present invention, on the occasion when downloading electronic ticket data from a server of a ticket agency or the like, if a storage medium such as an IC card to store the data is not mounted in a data processing terminal, or the storage medium has no sufficient space left to store the data, the data is encrypted and temporarily stored in an internal memory or a storage device having a capacity larger than that of the internal memory of the data processing terminal. When the storage medium has been mounted in the data processing terminal, the electronic ticket data is read out of the internal memory or the storage device. Thereafter, the electronic ticket data read out of the internal memory or the storage device is decrypted and stored in the storage medium. Thus, it becomes possible to download information such as electronic ticket data while ensuring security.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing the construction of a data processing system according to the first embodiment of the present invention;

FIG. 2 is a sequence diagram showing the operation of the data processing system depicted in FIG. 1;

FIG. 3 is a sequence diagram showing the operation of the data processing system depicted in FIG. 1;

FIG. 4 is a block diagram showing the construction of a data processing system according to the second embodiment of the present invention;

FIG. 5 is a sequence diagram showing the operation of the data processing system depicted in FIG. 4; and

FIG. 6 is a sequence diagram showing the operation of the data processing system depicted in FIG. 4.

### DESCRIPTION OF THE PREFERRED EMBODIMENTS

Referring now to the drawings, a description of preferred embodiments of the present invention will be given in detail.

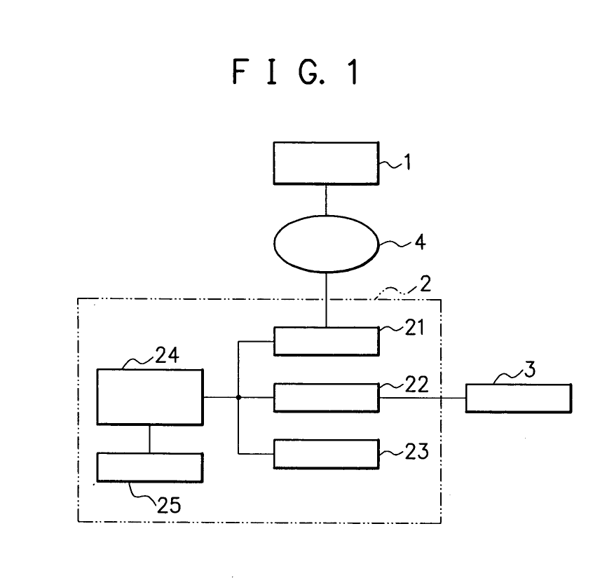

FIG. 1 is a block diagram showing the construction of a data processing system according to the first embodiment of the present invention. Referring to FIG. 1, the data processing system comprises an electronic ticket sales server 1 for offering electronic tickets, a cellular phone 2 carried by a user, and a communication network 4. The electronic ticket sales server 1 and the cellular phone 2 are connected with each other through the communication network 4. The cellular phone 2 has a construction such that an IC card 3 can be freely attached or removed to or from it. Electronic ticket data is to be stored in the IC card 3.

The cellular phone 2 is provided with a communication section 21 for communicating with the electronic ticket sales server 1 through the communication network 4, an IC card reader/writer 22 for reading out/writing data from/to the IC card 3, an internal memory 23, a controller (CPU) 24 for controlling the respective sections, and a read only memory (ROM) 25 for storing a program. The controller 24 operates according to the program.

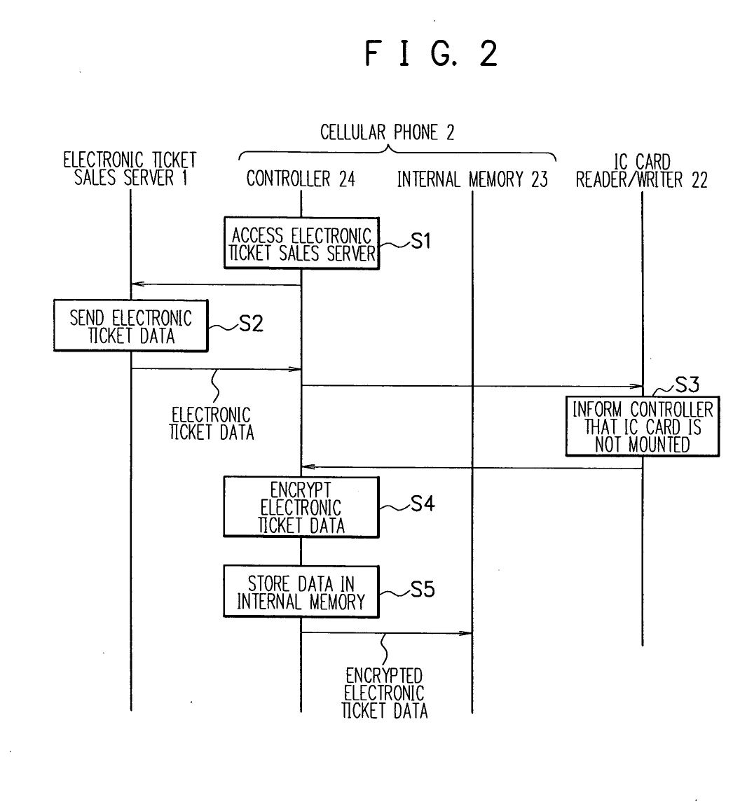

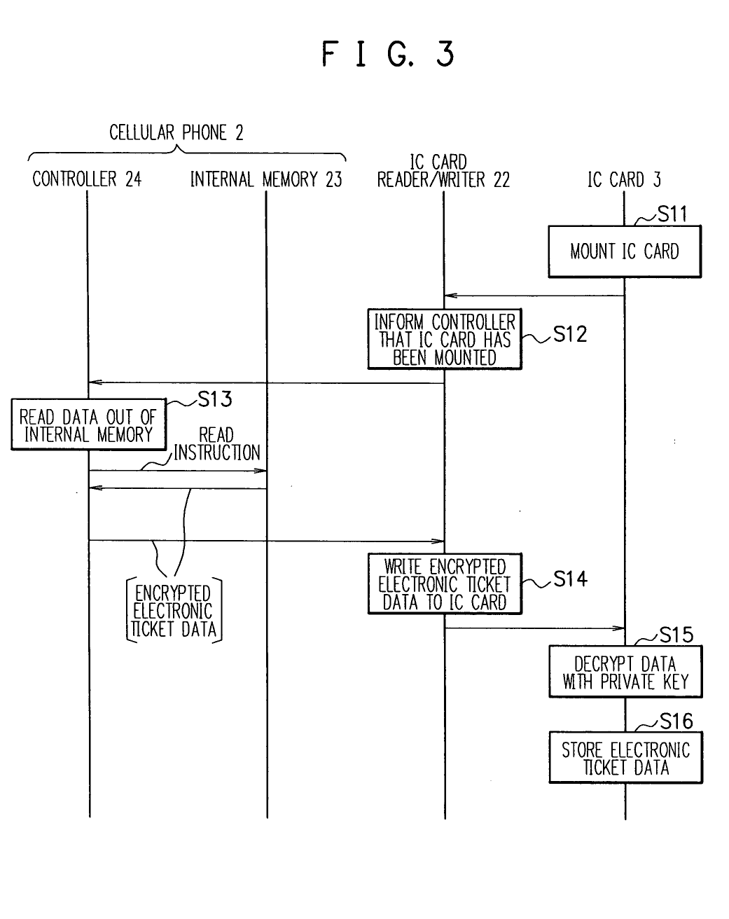

In the following, the operation of the data processing system according to the first embodiment will be described. FIGS. 2 and 3 are sequence diagrams each showing the operation of the data processing system depicted in FIG. 1.

First, a description will be made of the case where the user obtains an electronic ticket when the IC card 3 is not mounted in the cellular phone 2 with reference to FIG. 2. In order to obtain an electronic ticket, the user accesses the electronic ticket sales server 1 through the cellular phone 2 (step S1). Having been connected to the electronic ticket sales server 1, the cellular phone 2 displays screen guidance on its display section (not shown). The user operates the cellular phone 2 according to the screen guidance so that desired electronic ticket data is sent from the electronic ticket sales server 1 (step S2). When the cellular phone 2 receives the electronic ticket data, the controller 24 attempts to store the data in the IC card 3 via the IC card reader/writer 22. On this occasion, the IC card reader/writer 22 informs the controller 24 that the IC card 3 is not mounted in the cellular phone 2 (step S3).

On receipt of the information, the controller 24 encrypts the electronic ticket data with a public key to the IC card 3 to generate encrypted electronic ticket data (step S4). Subsequently, the controller 24 temporarily stores the encrypted electronic ticket data in the internal memory 23 (step S5). In this case, the controller 24 retains information that the electronic ticket data is supposed to be stored in the IC card 3. Alternatively, the information may be appended to the encrypted electronic ticket data as additional information.

Next, referring to FIG. 3, a description will be made of operation when the IC card 3 has been mounted in the cellular phone 2 after a sequence of operation shown in FIG. 2. When the user mounts or sets the IC card 3 in the cellular phone 2 (step S11), the IC card reader/writer 22 informs the controller 24 that the IC card 3 has been mounted in the cellular phone 2 (step S12). In response to receipt of the information, the controller 24 reads the encrypted electronic ticket data out of the internal memory 23 (step S13). After that, the controller 24 verifies whether the encrypted electronic ticket data is to be stored in the IC card 3 based on the information retained therein or the additional information appended to the data, and sends or writes the data to the IC card 3 through the IC card reader/writer 22 (step S14). Having received the encrypted electronic ticket data, the IC card 3 decrypts the data with a private or secret key to the IC card 3 (step S15). Thereby, the electronic ticket data is stored in the IC card 3 as it should be (step S16).

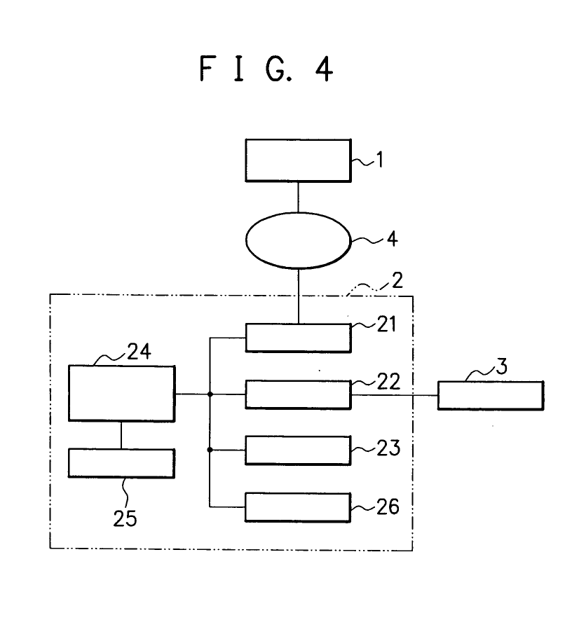

FIG. 4 is a block diagram showing the construction of a data processing system according to the second embodiment of the present invention. In FIG. 4, components or parts similar to those previously described with reference to FIG. 1 are denoted by the same reference numerals. The data processing system of the second embodiment has essentially the same construction as described previously for that of the first embodiment shown in FIG. 1 except that the cellular phone 2 further includes an SD (Secure Digital) card or SD memory 26. In this embodiment, when the IC card 3 is not mounted in the cellular phone 2 and also the internal memory 23 has no sufficient space left to store data, the data is temporarily stored in the SD card 26.

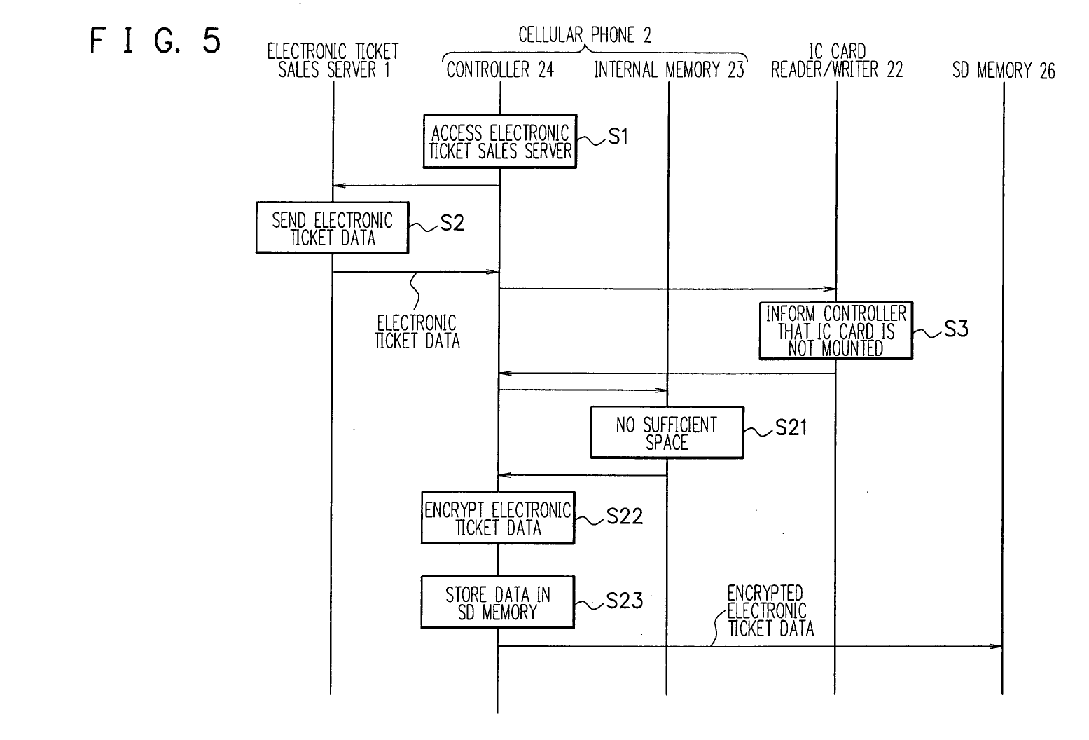

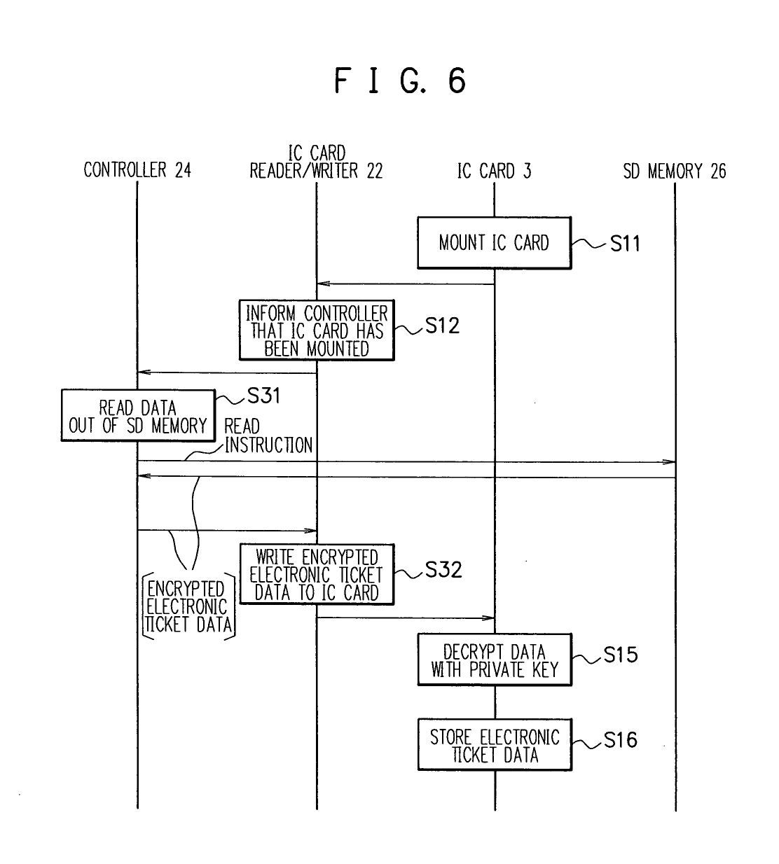

In the following, the operation of the data processing system according to the second embodiment will be described. FIGS. 5 and 6 are sequence diagrams each showing the operation of the data processing system depicted in FIG. 4. In FIGS. 5 and 6, steps similar to those previously described with reference to FIGS. 2 and 3 are denoted by the same reference numerals.

First, a description will be made of the case where the user obtains electronic ticket data when the IC card 3 is not mounted in the cellular phone 2 with reference to FIG. 5. Having received the information that the IC card 3 is not mounted in the cellular phone 2 (step S3) after steps S1 and S2, the controller 24 attempts to temporarily store the data in the internal memory 23. On this occasion, if it is determined that the internal memory 23 has no sufficient space and is not available for storing the data temporarily (step S21), the controller 24 encrypts the electronic ticket data with a public key to the IC card 3 to generate encrypted electronic ticket data (step S22). Subsequently, the controller 24 temporarily stores the encrypted electronic ticket data in the SD memory 26 (step S23). In this case, the controller 24 retains information that the electronic ticket data is supposed to be stored in the IC card 3. Alternatively, the information may be appended to the encrypted electronic ticket data as additional information.

Next, referring to FIG. 6, a description will be made of operation when the IC card 3 has been mounted in the cellular phone 2 after a sequence of operation shown in FIG. 5. Having received information that the IC card 3 has been mounted in the cellular phone 2 (step S12) after step S11, the controller 24 reads the encrypted electronic ticket data out of the SD memory 26 (step S31). After that, the controller 24 verifies whether the encrypted electronic ticket data is to be stored in the IC card 3 based on the information retained therein or the additional information appended to the data, and sends or writes the data to the IC card 3 through the IC card reader/writer 22 (step S32). Having received the encrypted electronic ticket data, the IC card 3 decrypts the data with a private or secret key to the IC card 3 (step S15). Thereby, the electronic ticket data is stored in the IC card 3 as it should be (step S16).

Incidentally, while the IC card 3 is employed in the embodiments described above, any detachable or removable storage medium can be utilized. Examples of the storage medium include an IC chip, an SD card, an MMC (Multimedia Card), a memory stick, a magnetic card, a smart media, an ATA (Attachment), a MOPASS (Mobile Passport) card, and a CF (Compact Flush: registered trade name) card. Besides, the present invention is applicable even when the storage medium cannot be attached or removed to or from the cellular phone in cases, as for example where the cellular phone is provided with a plurality of memory areas and one of the memory areas for storing electronic ticket data is full or there is no enough space therein.

Further, while encryption and decryption according to the public key cryptosystem have been cited as an example, the common key cryptosystem may also be employed. In other words, any system which protects electronic ticket data from illegal acts may be adopted. In addition, electronic ticket data has been cited merely by way of example and without limitation. The present invention is widely applicable, and other electronic content data may be obtained with the use of a portable information terminal such as a PDA (Personal Digital Assistant), PC (Personal Computer) or the like as well as a cellular phone.

Still further, it is obvious that procedural steps in a sequence of operation shown in each of FIGS. 2, 3, 5 and 6 can be implemented by the controller or CPU 24 of a computer under the control of a program previously stored in the ROM 25.

As set forth hereinabove, in accordance with the present invention, when a detachable or removable storage medium is not mounted in a data processing terminal such as a cellular phone, or when the storage medium has no sufficient space, electronic ticket data is temporarily stored in an internal memory or a storage device of the data processing terminal. Thus, the electronic ticket data can be downloaded from a server of a ticket agency or a ticket shop even in such cases.

Moreover, in accordance with the present invention, electronic ticket data is encrypted with a public key to the storage medium when the data is stored temporarily. Thus, it is possible to protect the electronic ticket data being temporarily stored from illegal acts such as falsification of data and unauthorized copying.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A data processing system, in which data received through a communication network is stored in a storage medium capable of being freely attached to and removed from a data processing terminal, wherein:
the data processing terminal includes a controller and an internal memory;
in the case where the storage medium is not mounted in the data processing terminal, data is encrypted and temporarily stored in the internal memory; and
the data stored in the internal memory is stored in the storage medium under the control of the controller when the storage medium has been mounted in the data processing terminal.

2. A data processing system, in which data received through a communication network is stored in a storage medium capable of being freely attached to and removed from a data processing terminal, wherein:
the data processing terminal includes an internal memory, a storage device having a capacity larger than that of the internal memory, and a controller;
in the case where the storage medium is not mounted in the data processing terminal and also the internal memory has no sufficient space left to store data, the data is encrypted and temporarily stored in the storage device; and
the data stored in the storage device is stored in the storage medium under the control of the controller when the storage medium has been mounted in the data processing terminal.

3. The data processing system claimed in claim 1, wherein the data is decrypted when stored in the storage medium.

4. The data processing system claimed in claim 2, wherein the data is decrypted when stored in the storage medium.

5. The data processing system claimed in claim 1, wherein:
the data is decrypted when stored in the storage medium; and
the data is electronic ticket data.

6. The data processing system claimed in claim 2, wherein:
the data is decrypted when stored in the storage medium; and
the data is electronic ticket data.

7. The data processing system claimed in claim 1, wherein:
the data is decrypted when stored in the storage medium;
the data is electronic ticket data; and
the data processing terminal is a cellular telephone.

8. The data processing system claimed in claim 2, wherein:
the data is decrypted when stored in the storage medium;
the data is electronic ticket data; and
the data processing terminal is a cellular telephone.

9. A data processing method for storing data received through a communication network in a storage medium which is capable of being mounted in a data processing terminal, comprising the steps of:
encrypting data to temporarily store the data in an internal memory of the data processing terminal in the case where the storage medium is not mounted in the data processing terminal; and
storing the data stored in the internal memory in the storage medium when the storage medium has been mounted in the data processing terminal.

10. A data processing method for storing data received through a communication network in a storage medium which is capable of being mounted in a data processing terminal, comprising the steps of: encrypting data to temporarily store the data in a storage device of the data processing terminal having a capacity larger than that of an internal memory thereof in the case where the storage medium is not mounted in the data processing terminal and also the internal memory has no sufficient space left to store the data; and
storing the data stored in the storage device in the storage medium when the storage medium has been mounted in the data processing terminal.

11. The data processing method claimed in claim 9, wherein the data is decrypted when stored in the storage medium.

12. The data processing method claimed in claim 10, wherein the data is decrypted when stored in the storage medium.

13. The data processing method claimed in claim 9, wherein:
the data is decrypted when stored in the storage medium; and
the data is electronic ticket data.

14. The data processing method claimed in claim 10, wherein:
the data is decrypted when stored in the storage medium; and
the data is electronic ticket data.

15. The data processing method claimed in claim 9, wherein:
the data is decrypted when stored in the storage medium;
the data is electronic ticket data; and
the data processing terminal is a cellular telephone.

16. The data processing method claimed in claim 10, wherein:
the data is decrypted when stored in the storage medium;
the data is electronic ticket data; and
the data processing terminal is a cellular telephone.

17. A data processing terminal, which stores data received through a communication network in a storage medium capable of being freely attached to and removed from the data processing terminal, comprising a controller and an internal memory, wherein:
in the case where the storage medium is not mounted in the data processing terminal, data is encrypted and temporarily stored in the internal memory; and
the data stored in the internal memory is stored in the storage medium under the control of the controller when the storage medium has been mounted in the data processing terminal.

18. A data processing terminal, which stores data received through a communication network in a storage medium capable of being freely attached to and removed from the data processing terminal, comprising an internal memory, a storage device having a capacity larger than that of the internal memory, and a controller, wherein:
in the case where the storage medium is not mounted in the data processing terminal and also the internal memory has no sufficient space left to store data, the data is encrypted and temporarily stored in the storage device; and
the data stored in the storage device is stored in the storage medium under the control of the controller when the storage medium has been mounted in the data processing terminal.

19. The data processing terminal claimed in claim 17, wherein the data is decrypted when stored in the storage medium.

20. The data processing terminal claimed in claim 18, wherein the data is decrypted when stored in the storage medium.

21. The data processing terminal claimed in claim 17, wherein:
the data is decrypted when stored in the storage medium; and
the data is electronic ticket data.

22. The data processing terminal claimed in claim 18, wherein:
the data is decrypted when stored in the storage medium; and
the data is electronic ticket data.

23. The data processing terminal claimed in claim 17, wherein:
the data is decrypted when stored in the storage medium;
the data is electronic ticket data; and
the data processing terminal is a cellular telephone.

24. The data processing terminal claimed in claim 18, wherein:
the data is decrypted when stored in the storage medium;
the data is electronic ticket data; and
the data processing terminal is a cellular telephone.

25. A data processing program for a computer to control the operations of a data processing terminal which stores data received through a communication network in a storage medium capable of being freely attached to and removed from the data processing terminal, the program making the data processing terminal perform the processes of:
encrypting data to temporarily store the data in an internal memory in the case where the storage medium is not mounted in the data processing terminal; and
storing the data stored in the internal memory in the storage medium when the storage medium has been mounted in the data processing terminal.

26. A data processing program for a computer to control the operations of a data processing terminal which stores data received through a communication network in a storage medium capable of being freely attached to and removed from the data processing terminal, the program making the data processing terminal perform the processes of:
encrypting data to temporarily store the data in a storage device having a capacity larger than that of an internal memory in the case where the storage medium is not mounted in the data processing terminal and also the internal memory has no sufficient space left to store the data; and
storing the data stored in the storage device in the storage medium when the storage medium has been mounted in the data processing terminal.
